(19) United States
(12) Patent Application Publication
(10) Pub. No.: US 2008/0028957 A1
(43) Pub. Date: Feb. 7, 2008

(54) Method for Carrying Out Direct and Indirect Orlov Printing and Printed Image

(76) Inventors: Sergei Y. Vyazalov, St. Petersburg (RU); Arkady V. Trachuk, St. Petersburg (RU); Aleksandr V. Kurochkin, Moscow (RU); Andrey V. Cheglakov, Moscow (RU); Aleksandr G. Pisarev, Moscow (RU); Mihail I. Goncharov, Moscow (RU); Evgenly B. Sokolov, Perm (RU); Konstantin G. Rybin, Perm (RU)

Correspondence Address: NIXON & VANDERHYE, PC, 901 NORTH GLEBE ROAD, 11TH FLOOR, ARLINGTON, VA, 22203, US

(21) Appl. No.: 11/630,271

(22) PCT Filed: Jun. 21, 2005
(86) PCT No.: PCT/RU05/00338

§ 371 Date: Apr. 23, 2007

(30) Foreign Application Priority Data
Jun. 25, 2004 (RU) 2004119163

(51) Int. Cl. B41F 5/16

(52) U.S. Cl. 101/177

(57) ABSTRACT

The invention relates to a method for carrying out direct or indirect Orlov printing. The essence of the invention lies in that applying rollers which are embodied in such a way that it is possible to form areas of multicolored strips on a plate cylinder and which are freely mounted with respect thereto are used for inking up the areas of an assembled printing plate of the plate cylinder.

The invention relates to the printing art, exactly, to the printing method known as “Orlov printing,” and can be used to print securities and also to print other multicolor printing production that requires protection.

Known are a method for carrying out direct or indirect Orlov printing and a printed image, said method comprising the steps of: inking up areas of an assembled printing plate of a plate cylinder with multicolored inks to form a color interposition zone between original ink areas; using a template roller or an intermediate roller of an ink-running-up group in cooperation with the plate cylinder; and then transferring the resulted ink image from the printing plate of the plate cylinder directly onto paper or an intermediate blanket cylinder (see RF Patent No 2,143,344, IPC B41M 3/14; Dec. 27, 1999—the similar prior art and closest similar prior art (prototype)).

The disadvantage of the prior art method is an insufficient number of variants of the color gamut produced within a smooth ink transition zone, which results negatively in the security protection quality.

It is the technical result of the invention to improve the security protection quality.

Said result is accomplished in that there are the following steps to ink up areas of the assembled printing plate of the plate cylinder: using applying rollers freely mounted with respect to said cylinder so as to form areas of multicolored ink strips on the plate cylinder, said strips being oriented in a rotation direction of the plate cylinder, and to form boundaries between strips with a sharp transition and/or a smooth iris transition and/or a space zone; and then transferring an ink layer from areas of two or more strips on the plate cylinder onto the template roller or the intermediate roller included in the ink-running-up group with a drum roller capable of axial reciprocation to mix original inks in printing members embodied on the template roller, wherein formation of the color imposition zone includes transfer of inks simultaneously with return of the inks to the assembled printing plate areas whose configuration is determined by the printing members of the template roller, with complete or partial overlap of the ink strips and their boundary areas by mix zones.

Two template rollers are used that are mounted so as to apply a mixture of original inks onto similar areas of the assembled printing plate.

In order to create a smooth transition within the color imposition zones during division of ink colors in the axial direction, one or more template rollers are or the drum roller is embodied so as to allow their or its reciprocation.

In order to create a smooth transition within the color imposition zones during division of ink colors in the rotation direction of the plate cylinder, one or more template rollers are or the drum roller is embodied so as to allow their or its pulsing movement in the rotary direction of the plate cylinder.

A printed image is generated in accordance with said features.

The essence of the direct or indirect Orlov printing method is implemented as follows and is explained by the followed drawings, wherein:

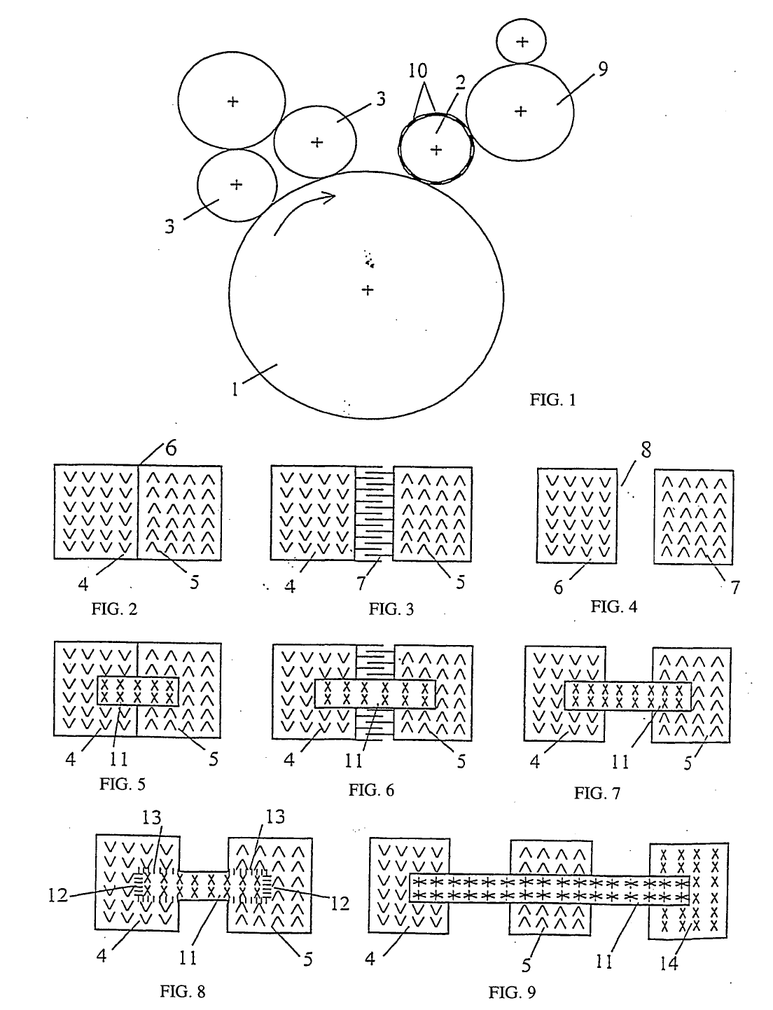

FIG. 1 shows a diagram of an embodiment of a printing apparatus;

FIGS. 2, 3, 4 show different types of boundary areas of ink strips;

FIGS. 5, 6, 7, 9 show different types of a printed image within a color imposition zone; and

FIG. 9 shows an image with three original inks.

The direct or indirect Orlov printing method consists in: inking up areas of an assembled printing plate of a plate cylinder 1 by multicolored inks to form a color imposition zone between original ink areas; using a template roller 2 or an intermediate roller (not shown) included in an ink-running-up group and cooperating with the plate cylinder 1; and then transferring the resulted ink image from the printing plate of the plate cylinder 1 directly onto paper or an intermediate blanket cylinder (not shown).

In order to ink up the areas of the printing plate of the plate cylinder 1, applying rollers 3 are used that are freely mounted with respect to said cylinder so as to form areas of multicolored ink strips 4, 5, 14 on the plate cylinder 1, said strips being oriented in a rotation direction of the plate cylinder, and to form boundaries 6 between strips 4, 5 with a sharp transition and/or a smooth iris transition 7 and/or a space zone 8.

Then transfer of an ink layer from areas of two or more strips 4, 5 on the plate cylinder 1 onto the template roller 2 or the intermediate roller is carried out with a drum roller 9 capable of axial reciprocation to mix original inks in printing members 10 embodied on the template roller 2.

Formation of a color imposition zone 11 includes transfer of inks simultaneously with return of the inks to areas of the printing plate 1 whose configuration is determined by the printing members 10 of the template roller 2, with complete or partial overlapping the ink strips and their boundary areas by mix zones.

Two template rollers 2 are used that cooperate with each other.

In order to create a smooth transition 12 within the color imposition zones 11 during division of ink colors in the axial direction, one or more template rollers 2 are or the drum roller 9 is embodied so as to allow their or its reciprocation.

In order to create a smooth transition 13 within the color imposition zones 11 during division of ink colors in the rotation direction of the plate cylinder 1, one or more template rollers 2 are or the drum roller 9 is embodied so as to allow their or its pulsing movement in the rotary direction of the plate cylinder 1 having the assembled printing plate.

A printed image is generated in accordance the method according to any one of said features.

The method is carried out as follows.

The assembled printing plate of the plate cylinder 1 is inked up in necessary locations by inks of two or more different colors using the applying rollers 3 that have oriented ink strips 4, 5 while boundaries between said strips are embodied with the sharp transition 6 and/or with the smooth iris transition 7 and/or with the space zone 8. A combination of boundary area types in the image and variants of their alternation may be different, and this improves the protection against counterfeit.

A separate ink-running-up group not coupled to a primary inking-up group includes the template roller 2 that removes two or more original inks from the assembled plate 1. It is possible to remove inks via intermediate rollers and then to transfer the inks onto the template roller. It is possible to mount a second template roller 2 in conformance with the first template roller to provide more stable mixing of the original inks. A mixture of two or more original inks is produced from said original inks due to axial reciprocation of the drum roller 9 over the printing members 10 of the template roller 2, said mixture being different in color from the original inks. Simultaneously, the mixture of the original inks is supplied back onto the assembled printing plate of the plate cylinder 1 at necessary locations whose configuration is determined by the printing members 10 lied on the template roller 2 and embodied in the form of various geometrical figures, patterns, etc., which is provided by mutually conformed teeth engagement of the template roller 2 and the plate cylinder 1. The thus-generated multicolor image (FIGS. 2 to 9) in the form of continuously colored lines is transferred directly from the assembled plate onto paper (direct Orlov printing) or onto a resin web of the blanket cylinder (indirect Orlov printing).

If one or more the rollers 2 or the cylinders 9 of the separate ink-running-up group is or are driven into axial reciprocation, the continuously colored lines that generate a multicolor pattern will have the smooth transition 12 within the ink imposition zones in the direction of a generating line of the plate cylinder 1.

Cyclic pulsing movement of the roller(s) 2 or the cylinder(s) 9 of the separate ink-running-up group in the rotation direction of the plate cylinder allows smooth boundaries of the transition 13 within the ink imposition zones for continuously colored lines in the rotary direction of the plate cylinder 1.

Cyclic circumferential and axial movement of the template roller 2 or the cylinders 9 of the separate ink-running-up group can take place both simultaneously and separately, wherein different iris effects take place at superposition of mix inks 11.

All this in complex improves the protective effect of the inventive Orlov printing method due to more variability of the resulted image and improvement in its multi-coloration during manufacture of protected printing-art production.

1. A method for carrying out direct or indirect Orlov printing, comprising the steps of: inking up areas of an assembled printing plate of a plate cylinder with multicolored inks to form a color interposition zone between original ink areas; using a template roller or an intermediate roller of an ink-running-up group in cooperation with the plate cylinder; and then transferring the resulted ink image from the printing plate of the plate cylinder directly onto paper or an intermediate blanket cylinder; said method being characterized in that there are the following steps to ink up areas of the assembled printing plate of the plate cylinder: using applying rollers freely mounted with respect to said cylinder so as to form areas of multicolored ink strips on the plate cylinder, said strips being oriented in a rotation direction of the plate cylinder, and to form boundaries between strips with a sharp transition and/or a smooth iris transition and/or a space zone; and then transferring an ink layer from areas of two or more strips on the plate cylinder onto the template roller or the intermediate roller included in the ink-running-up group with a drum roller capable of axial reciprocation to mix original inks in printing members embodied on the template roller, wherein formation of the color imposition zone includes transfer of inks simultaneously with return of the inks to the assembled printing plate areas whose configuration is determined by the printing members of the template roller, with complete or partial overlap of the ink strips and their boundary areas by mix zones.

2. A method according to claim 1, characterized by using two template rollers mounted so as to apply a mixture of original inks onto similar areas of the assembled printing plate.

3. A method according to claim 1, characterized in that, in order to create a smooth transition within the color imposition zones during division of ink colors in the axial direction, one or more template rollers are or the drum roller is embodied so as to allow their or its reciprocation.

4. A method according to claim 1, characterized in that, in order to create a smooth transition within the color imposition zones during division of ink colors in the rotation direction of the plate cylinder, one or more template rollers are or the drum roller is embodied so as to allow their or its pulsing movement in the rotary direction of the plate cylinder.

5. A printed image generated in accordance with the method according to claim 1.
